(19) United States
(12) Patent Application Publication
(10) Pub. No.: US 2012/0171356 A1
(43) Pub. Date: Jul. 5, 2012

(54) SYSTEM FOR DIGITAL DEPOSITION OF PAD / INTERCONNECTS COATINGS

(75) Inventors: Muhammad Iraqi, Tira (IL); Avi Levy, Mitzpe Aviv (IL); Eva Igner, Haifa (IL)

(73) Assignee: CAMTEK LTD., Migdal Haemek (IL)

(21) Appl. No.: 13/310,807

(22) Filed: Dec. 5, 2011

Related U.S. Application Data
(60) Provisional application No. 61/427,218, filed on Dec. 27, 2010.

(51) Int. Cl. B05D 5/00; B05D 1/36; B05C 11/00

(52) U.S. Cl. 427/8; 118/300; 118/712; 427/256; 427/259

(57) ABSTRACT

A method and a system for printing patterns on an object, is provided. The system may include a copper protective coating printing unit arranged to print copper protective coating ink on the object to provide at least one copper protective coating ink pattern. The system may include zero or more additional printing units selected out of a solder mask printing unit arranged to print solder mask ink on the object to provide at least one solder mask pattern and a notation mark printing unit arranged to print notation mark ink on the object to provide at least one notation mark pattern. The system also includes at least one curing unit arranged to cure each ink printed by each printing unit.

### RELATED APPLICATIONS

This application claims the priority of U.S. provisional patent 61/427,218, filing date Dec. 27, 2010 which is incorporated herein by reference.

### BACKGROUND

Printed Circuit Boards (PCBs) consisting of some substrate material selectively covered by conductive traces and partially covered by an insulating layer are used in electronic manufacturing as the basis for interconnecting the various electronic components that perform the desired function. The final products include many materials that are manufactured by a complex and aggressive manufacturing process during which the PCBs are subjected to chemicals, to thermal and mechanical stress and other forces.

The conductive traces on such PCBs are usually made of copper and are coated with an insulating material called “solder mask” or “solder resist” in order to protect the copper traces. Certain portions of the copper designed to electrically and mechanically attach the electronic components are left unprotected by the insulating material to allow the attachment by soldering. These areas (usually called “pads” or “landing pads”), have also to be protected against oxidation in order to enable proper solder attachment of components. Copper areas that do not need to be exposed for component mounting, are covered with solder mask while copper areas, that need to be exposed (pads) are coated using various materials and methods such as tin and the hot air solder leveling (HASL process), Nickel & gold and the electro-less nickel immersion gold (ENIG) process, Silver, organic solderability preservative or organic surface protection (OSP) process, etc.

Most methods used for coating the exposed copper areas (pads) use acidic materials and are extremely unfriendly to the environment. They incur energy waste and involve contaminants that have to be dealt with after their use. These methods are costly and require controlled pollutant disposal.

In the PCB finishing industry a great deal of interest has been expressed in organic solderability protection (OSPs) as copper protective coatings or anti-tarnish copper protective coatings. OSP is a method for plating printed circuit boards. It is a water-based organic compound that selectively bonds to copper and provides an organometallic layer that protects the copper during soldering. Deposition of OSP includes soaking the entire PCB in multiple relatively large chemical baths.

There is a growing need to provide efficient pad and interconnect coatings using inkjet printing methods.

Bare copper is only solderable when it is unoxidized, so it needs protection from oxidation: a number of organic “anti-tarnish” finishes or “corrosion inhibitors” based on imidazole or triazole chemistries that have been found to be effective against undesirable surface oxidation reactions can be used in formulations to be deposited on the clean copper surfaces.

Formulations based on dispersed submicronic metals such as silver, gold, tin can deposited on the copper surfaces as finishing protecting metals against copper surfaces oxidations reactions.

### SUMMARY OF THE INVENTION

A system and method is provided to print solder masks and/or protective coatings and/or metal coatings and/or printing patterns and/or notation marks, etc.

A system may be provided to digitally print (by using inkjets) protective coating over portions of conductors that are not covered by solder mask. The coating can be one of those mentioned above and may protect the surface and/or allow solderability.

The printing may be performed using inkjet techniques.

The printing of the coating may occur prior to the application of solder mask coating or after the solder mask has been applied.

The system may include at least one additional printing units selected out of a solder mask printing unit arranged to print solder mask ink on the object to provide at least one solder mask pattern and a notation mark printing unit arranged to print notation mark ink on the object to provide at least one notation mark pattern; wherein the at least one additional printing unit and the copper protective coating printing unit for multiple printing units.

The at least one curing unit may be arranged to cure each type of ink printed by each additional printing unit.

Furthermore, a system may be provided for printing patterns on an object which may include multiple printing units, wherein the multiple printing units may include: a solder mask printing unit arranged to print solder mask ink on the object to provide at least one solder mask pattern; a notation mark printing unit arranged to print notation mark ink on the object to provide at least one notation mark pattern; a copper protective coating printing unit arranged to print copper protective coating ink on the object to provide at least one copper protective coating ink pattern; and at least one curing unit arranged to cure each of the solder mask ink and/or the notation mark ink and/or the copper protective coating ink. The said printing units may print in any order or concurrently.

The object can be a substrate, a printed circuit board, a plate that includes multiple printed circuit boards, a wafer and the like.

The at least two printing units may be arranged to print simultaneously on different areas of the object.

The multiple printing units may be arranged to print simultaneously on different areas of the object.

The system further may include motors that introduce movement between the object and each of the multiple printing units.

The fields of view of different printing units may or may not overlap.

The multiple printing units may be connected to rigid bridges, wherein an upper portion of each of the rigid bridges is positioned above a stage that may be arranged to support the object and move the object during the printing of patterns.

The system further may include an inspection unit arranged to generate images of portions of the object.

The system may include a controller arranged to process the images, detect a repairable defect and instruct at least one printing unit to repair the repairable defect by performing an additional printing process.

Each one of the multiple printing units may be connected to a unique bridge.

Each one of the printing units may include an array of inkjets.

Each one of the printing units and at least one curing unit may be proximate to each other.

A method may be provided to print protective coating over portions of conductors that are not covered by solder mask. The coating can be one of those mentioned above and may protect the surface and/or allow solderability.

The printing may be performed using inkjet techniques.

The printing of the coating may occur prior to the application of solder mask coating or after the solder mask has been applied.

Furthermore, a method for printing patterns on an object may be provided and may include:

performing multiple printing operations; wherein the multiple printing operations may include: printing, by a solder mask printing unit of a system, solder mask ink on the object to provide at least one solder mask pattern; printing, by a notation mark printing unit of the system, notation mark ink on the object to provide at least one notation mark pattern; printing, by a copper protective coating printing unit of the system, copper protective coating ink on the object to provide at least one copper protective coating ink pattern. The method also may include curing, by at least one curing unit of the system, each of the solder mask ink and/or the notation mark ink and/or the copper protective coating ink.

The method may include performing at least two printing operations simultaneously on different areas of the object.

The method may include performing all printing operations simultaneously on different areas of the object.

Fields of view of different printing units may or may not overlap.

The method may include generating, by an inspection unit, images of portions of the object.

The method may include: processing the images, with a controller; detecting a repairable defect, by the controller; and instructing at least one printing unit to repair the repairable defect by performing an additional printing process.

According to an embodiment of the invention a system can be provided for performing only one type of printing—copper protective coating. The system may include a copper protective coating printing unit arranged to print copper protective coating ink on the object to provide at least one copper protective coating ink pattern; and at least one curing unit arranged to cure the copper protective coating ink.

The system may include an inspection unit arranged to generate images of portions of the object.

The system may include a controller arranged to process the images, detect a repairable defect and instruct at least one printing unit to repair the repairable defect by performing an additional printing process.

The system may include an array of inkjets.

The printing unit and the curing unit may be proximate to each other.

The copper protective coating printing unit may be arranged to print organic solderability protection (OSP) ink.

According to an embodiment of the invention a method for printing patterns on an object can be provided and may include a single type of printing. The method may include printing, by a copper protective coating printing unit, copper protective coating ink on the object to provide at least one copper protective coating ink pattern; and curing, by at least one curing unit, the copper protective coating ink.

The method may include performing at least one additional sequence of stages out of: (A) printing, by a solder mask printing unit, solder mask ink on the object to provide at least one solder mask pattern; and curing the solder mark pattern; and (B) printing, by a notation mark printing unit, notation mark ink on the object to provide at least one notation mark pattern; and curing the notation mark pattern.

The method may include printing, by the solder mask printing unit, solder mask ink on the object to provide at least one solder mask pattern; curing the solder mark pattern; printing, by the notation mark printing unit, notation mark ink on the object to provide at least one notation mark pattern; and curing the notation mark pattern.

The method may include generating, by an inspection unit, images of portions of the object.

The method may include processing the images, with a controller; detecting a repairable defect, by the controller; and instructing, by the controller, at least one printing unit to repair the repairable defect by performing an additional printing process.

### BRIEF DESCRIPTION OF THE DRAWINGS

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

FIG. 1 illustrates a system according to an embodiment of the invention;

FIG. 2 illustrates a system, according to an embodiment of the invention;

FIG. 3 illustrates a method according to an embodiment of the invention;

FIG. 4 illustrates a method according to an embodiment of the invention; and

FIG. 5 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method is provided that can include digital pad coating using various materials such as metals, organic polymers, etc.

A highly effective printing system can digitally print copper protective coating ink instead of dipping the entire PCB in multiple large baths. The system may include a copper protective coating printing unit arranged to print copper protective coating ink using selective printing so that the copper protective coating ink is printed at desired locations without immersing the entire PCB in size consuming baths.

A highly effective system can combine printing of inks of various types. The printing units can be moved along one or more rigid bridges that allow accurate motion and facilitate highly accurate and fast printing by ink jets. The proximity between the different printing heads speeds up the printing process.

Such a system can facilitate digital material deposition, provide a single finishing setup/printer, replacing the current coating process by applying the coating material, and use inkjets for providing ink jet table coatings.

The system can include (a) a solder mask printing unit arranged to print solder mask ink on the object to provide at least one solder mask pattern; (b) a notation mark printing unit arranged to print notation mark ink on the object to provide at least one notation mark pattern; and (c) a copper protective coating printing unit arranged to print copper protective coating ink on the object to provide at least one copper protective coating ink pattern.

The copper protective coating printing unit can be arranged to print metal dispersions such as silver or gold dispersions on copper pads as copper protective coatings prior to solderability. The copper protective coating printing unit can print OSP coatings and metal coatings using ink-jet methods and thus enable a total digital solution for finishing of an object such as a PCB.

Used together with solder mask and notation ink application, OSP deposition enables a single system to efficiently complete all of the finishing steps of PCB manufacturing within a common system. This reduces handling, increases accuracy, improves yield, reduces cost and contributes to the environment by minimizing generation of pollutants that need controlled disposal method.

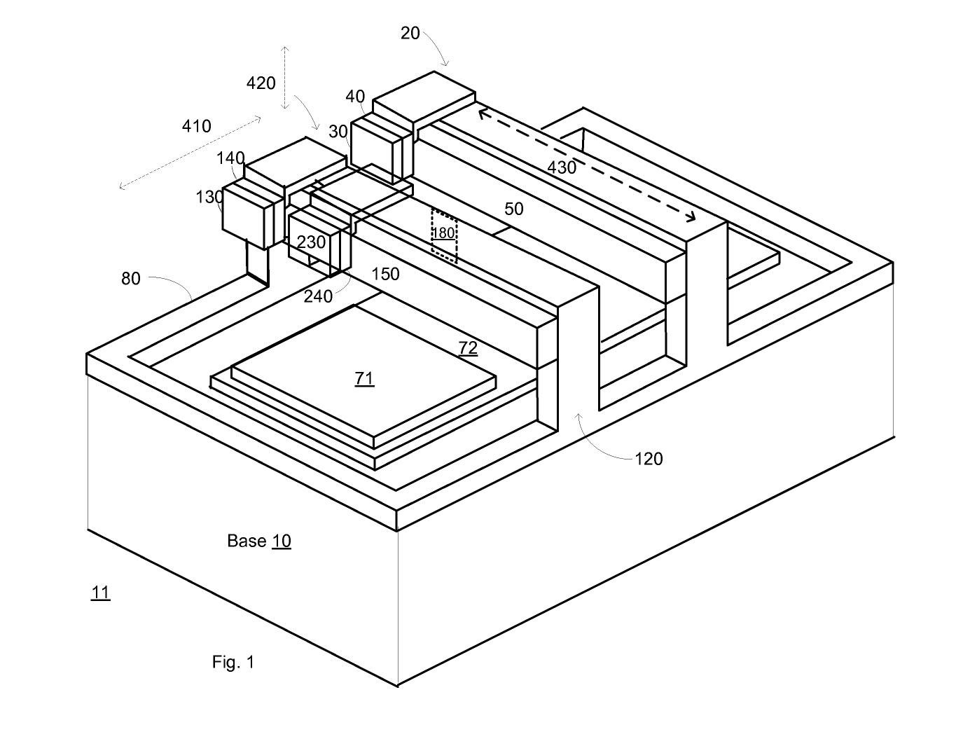

FIG. 1 illustrates a system 11 according to an embodiment of the invention.

The system 11 includes a base 10 that may include mechanical and electrical components such as a controller, ink supply mechanism for each type of ink, cooling elements and the like. System 11 includes two bridges 20 and 120, solder mask printing unit 30, notation mark printing unit 130 and copper protective coating printing unit 230.

FIG. 1 also illustrates an object handling sub-system that includes an object supporter 71 that is placed on motorized system 72 that may move the object supporter 71 on which a PCB can be placed. The object supporter 71 supports a PCB and may firmly hold it after the PCB is being aligned and positioned in a desired location and orientation.

The bridges 20 and 120 are connected to a rigid and stable frame 80.

First till third motors 40, 140 and 240 are connected to printing units 30, 130 and 230 respectively and each can move the associated printing head along (vertical) direction 420.

The motorized system 72 can move along a first direction 410 and the bridge motors (50 and 150) can move the different printing units 30, 130 and 230 along a second direction 430.

FIG. 1 illustrates the three directions 410, 420 and 430 as perpendicular to each other but this is not necessarily so.

The system 11 also may have one or more curing/drying units, such as curing unit 180 that is located at an opposite side of the second bridge and is illustrated by dashed box 180. Each curing/drying unit (such as unit 180) can be fixed to a bridge or be connected to a motor (such as first or second bridge motors or an additional (not shown) bridge motor) that can introduce movement in relation to a bridge.

All the mentioned above motors facilitate movements along various directions. For simplicity of explanation various structural elements connected to the motors or in touch with the motors (such as rails, chains and the like) are not shown.

First and second bridges 20 and 120 are fixed to the frame 80. Frame 80 is located in a horizontal plane and has a rectangular shape. It is noted that frame 80 may have other shapes and may be oriented in relation to the horizontal plane.

Each of the first and second bridges 20 and 120 provide a highly accurate and stable structure that does not move during the printed process and during the inspection process, and simplifies the control scheme of the imaging printing process.

The fixed and rigid bridges 20 and 120 do not include extensive moving parts and their maintenance is simple and low cost.

Each bridge 20 includes a horizontal structural element (that defines its longitudinal axis 430) and two vertical structural elements that define a space in which the PCB may move.

It is noted that one or more printing units can be combined and that each of the printing units 30, 130 and 230 can include print heads for printing different types of materials other than of solder mask ink, notation ink and copper protective coating.

Bridge 20 is configured to accommodate in a precise manner printing unit 30. Printing unit 30 may include jet nozzles for injecting a solder mask ink to form a solder mask on the surface of an object.

The jet nozzles of each of printing heads 30, 130 and 230 may be arranged in various manners. For example, jet nozzles may be arranged in lines that are parallel to each other and are spaced apart from each other to form an array of jet nozzles.

It is further noted that the number of bridges can exceed two (three, four and even more) and that there can also be only a single bridge.

It is further noted that the association of bridges to printing heads can differ from those illustrated in FIG. 1. For example—the first bridge 20 can support printing head 130 while the second bridge 120 can support the other printing heads.

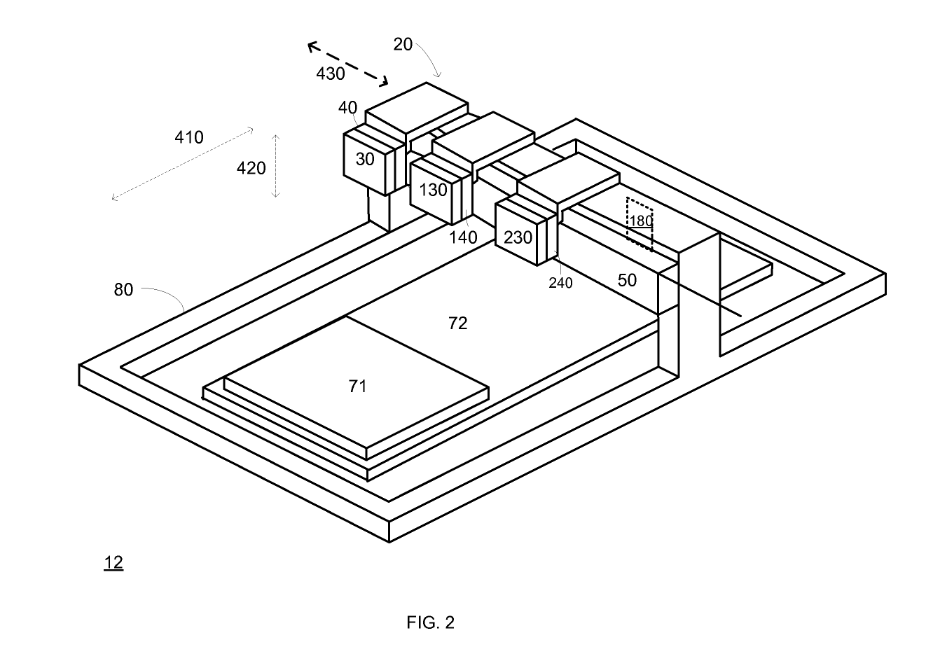

FIG. 2 illustrates a system 12 according to an embodiment of the invention. System 12 differs from system 11 by including a single bridge 20. All three motors 40, 140 and 140 are connected to the bridge motor 50.

It is further noted that any of the mentioned above systems can include one or more inspection units that can be connected to one or more bridge or to one or more motors. Such an inspection unit can be connected to a motor (such as 40) and to a bridge motor (such as 50).

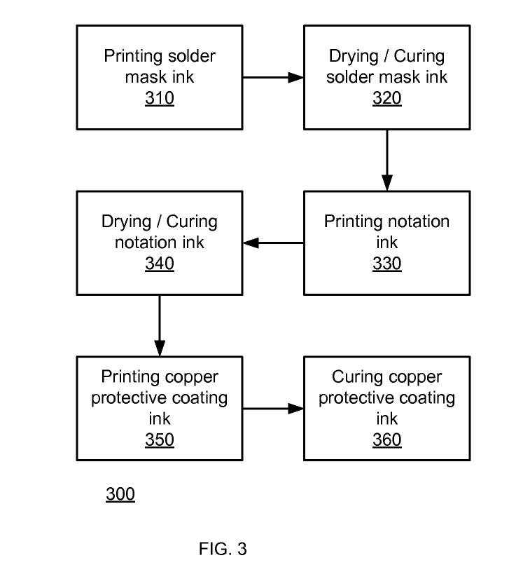

FIG. 3 illustrates method 300 according to an embodiment of the invention.

The method includes printing at least one solder mask pattern such as a desired solder mask, printing at least one notation pattern to provide desired notations and printing at least one copper protective coating pattern to protect desired locations of interest. The printing uses digital printing technology and involves inkjetting inks from inkjet nozzles and can be regarded as “inkjetting”.

Method 300 may start by stage 310 of printing solder mask ink to obtain a desired solder mask.

Stage 310 may be followed by stage 320 of curing or drying the solder mask ink. This may include curing the desired solder mask.

Stage 320 may be followed by stage 330 of notation ink to obtain desired notations. This may include forming one or more notation ink patterns.

Stage 330 may be followed by stage 340 of curing or drying the notation ink. This may include curing the one or more notation ink patterns.

Stage 340 may be followed by stage 350 of copper protective coating to protect desired copper pads or other elements from oxidation.

Stage 350 may be followed by stage 360 of curing or drying the copper protective coating ink. This may include curing the copper protective coating patterns formed on the object.

It is noted that the stages of method 300 can be performed in any other order.

Each of stages 310-360 can include moving the PCB, the printing unit and/or the curing unit such as to apply the ink or curing on the appropriate area of the PCB.

Method 300 can include one or more stages of inspecting the PCB to provide printing or curing control. One or more stages can be repeated or the product of such stage can be repaired as a result of an inspection.

It is noted that multiple stages of method 300 can be executed in parallel. For example, stage 310 can be applied on one area of the object while stage 330 and additionally or alternatively, stage 350 may be executed on other areas of the object. A predefined order between these stages can be applied to a certain area of the object but this is not necessarily so.

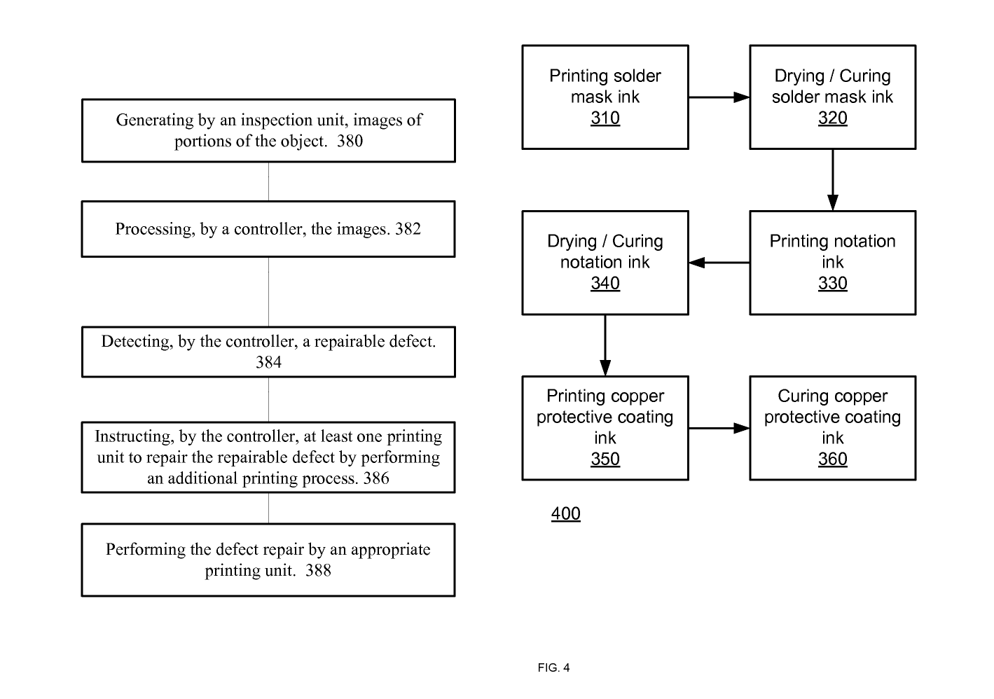

FIG. 4 illustrates method 400 according to an embodiment of the invention. Method 400 includes the stages of method 300 and also stages 380-388.

Stage 380 of generating by an inspection unit, images of portions of the object.

Stage 382 of processing, by a controller, the images; stage 384 of detecting, by the controller, a repairable defect.

Stage 386 of instructing, by the controller, at least one printing unit to repair the repairable defect by performing an additional printing process.

Stage 388 of performing the defect repair by an appropriate printing unit—the printing unit that can print the type of ink that is missing.

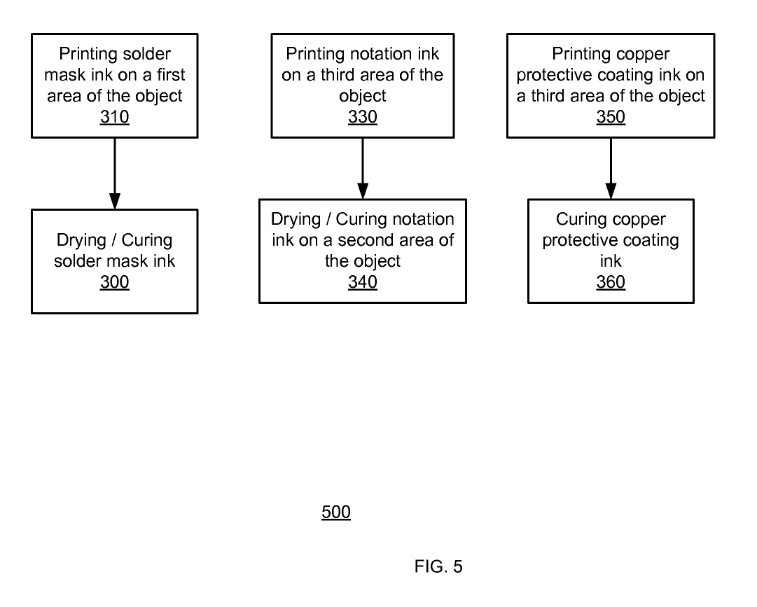

FIG. 5 illustrates method 500 according to an embodiment of the invention.

Method 500 illustrates that multiple printing stages such as stages 310, 330 and 350 can be executed in parallel to each other (over different areas of the object) while each stage is followed by a corresponding curing stage 320, 340 and 360.

It is noted that according to various embodiments of the invention various combination of one or more stages of method 500 can be provided. For example, a method can be provided for performing a single type of printing—copper protective coating alone.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A system for printing patterns on an object, the system comprising:
a copper protective coating printing unit arranged to print copper protective coating ink on the object to provide at least one copper protective coating ink pattern; and
at least one curing unit arranged to cure the copper protective coating ink.

2. The system according to claim 1, further comprising at least one additional printing units selected out of a solder mask printing unit arranged to print solder mask ink on the object to provide at least one solder mask pattern and a notation mark printing unit arranged to print notation mark ink on the object to provide at least one notation mark pattern; wherein the at least one additional printing unit and the copper protective coating printing unit for multiple printing units.

3. The system according to claim 2, wherein the at least one curing unit is further arranged to cure each type of ink printed by each additional printing unit.

4. The system according to claim 2, wherein the at least one additional printing units comprise the solder mask printing unit and the solder mask printing unit.

5. The system according to claim 2, wherein at least two printing units are arranged to print simultaneously on different areas of the object.

6. The system according to claim 2, wherein multiple printing units are arranged to print simultaneously on different areas of the object.

7. The system according to claim 2, further comprises motors that introduce movement between the object and each of the multiple printing units.

8. The system according to claim 2, wherein fields of view of different printing units do not overlap.

9. The system according to claim 2, wherein at least two fields of view of at least two printing units at least partially overlap.

10. The system according to claim 2, wherein the multiple printing units are connected to rigid bridges, wherein an upper portion of each of the rigid bridges is positioned above a stage that is arranged to support the object and move the object during the printing of patterns.

11. The system according to claim 2 further comprising an inspection unit arranged to generate images of portions of the object.

12. The system according to claim 11 further comprising a controller arranged to process the images, detect a repairable defect and instruct at least one printing unit to repair the repairable defect by performing an additional printing process.

13. The system according to claim 2, wherein each printing unit of the multiple printing units is connected to a unique bridge.

14. The system according to claim 2 wherein each of the printing units comprises an array of inkjets.

15. The system according to claim 2, wherein the printing units and the at least curing unit are proximate to each other.

16. The system according to claim 1 wherein the copper protective coating printing unit is arranged to print organic solderability protection (OSP) ink.

17. The system according to claim 1 further comprising an inspection unit arranged to generate images of portions of the object.

18. A method for printing patterns on an object, the method comprising:
printing, by a copper protective coating printing unit, copper protective coating ink on the object to provide at least one copper protective coating ink pattern; and
curing, by at least one curing unit, the copper protective coating ink.

19. The method according to claim 18, comprising performing at least one additional sequence of stages out of:
(A) printing, by a solder mask printing unit, solder mask ink on the object to provide at least one solder mask pattern; and curing the solder mark pattern; and
(B) printing, by a notation mark printing unit, notation mark ink on the object to provide at least one notation mark pattern; and curing the notation mark pattern.

20. The method according to claim 19, comprising printing, by the solder mask printing unit, solder mask ink on the object to provide at least one solder mask pattern; curing the solder mark pattern; printing, by the notation mark printing unit, notation mark ink on the object to provide at least one notation mark pattern; and curing the notation mark pattern.

21. The method according to claim 19, comprising performing at least two printing operations simultaneously on different areas of the object, wherein the printing operations are selected from (i) printing, by the copper protective coating printing unit, copper protective coating ink on the object to provide at least one copper protective coating ink pattern; (ii) printing, by the solder mask printing unit, solder mask ink on the object to provide at least one solder mask pattern; and curing the solder mark pattern; and (iii) printing, by the notation mark printing unit, notation mark ink on the object to provide at least one notation mark pattern; and curing the notation mark pattern.

22. The method according to claim 19, comprising introducing movement, by motors, movement between the object and each of the printing units.

23. The method according to claim 19, wherein fields of view of different printing units do not overlap.

24. The method according to claim 19, wherein at least two fields of view of at least two printing units at least partially overlap.

25. The method according to claim 19 further comprising generating images of portions of the object.

26. The method according to claim 25 further comprising processing the images, detecting a repairable defect and instructing at least one printing unit to repair the repairable defect by performing an additional printing process.

27. The method according to claim 18 wherein the copper protective coating printing unit is arranged to print organic solderability protection (OSP) ink.
